(19) United States
(12) Patent Application Publication
(10) Pub. No.: US 2011/0220706 A1
(43) Pub. Date: Sep. 15, 2011

(54) SECURE MAILING ENVELOPE AND METHOD FOR MANUFACTURING ENVELOPE

(75) Inventors: Christopher Benton, Chester (GB); James Meaton, Hampshire (GB); Simon Jones, Surrey (GB)

(73) Assignee: FREDRICKSON SECURE SERVICES LIMITED, London (GB)

(21) Appl. No.: 13/062,399

(22) PCT Filed: Sep. 4, 2009
(86) PCT No.: PCT/GB2009/002127

§ 371 Date: May 24, 2011

(30) Foreign Application Priority Data
Sep. 5, 2008 (GB) 0816302.4

(51) Int. Cl. B65D 27/00; B31B 1/00

(52) U.S. Cl. 229/68.1; 493/267

(57) ABSTRACT

A mailing envelope is disclosed, the envelope including an outer paper layer forming a pocket and an inner foil layer lining an inner surface of the outer paper layer within the pocket. The foil layer includes an aluminium foil having a thickness in a range of 6 to 10 μm. Also disclosed is a mailing envelope including an outer paper layer forming a pocket and an inner foil layer lining an inner surface of the outer paper layer within the pocket, wherein the inner foil layer includes an aluminium foil coated with a lacquer.

### PRIORITY CLAIM

The present application is a National Phase entry of PCT Application No. PCT/GB2009/002127, filed Sep. 4, 2009, which claims priority from Great Britain Application Number 0816302.4, filed Sep. 5, 2008, the disclosures of which are hereby incorporated by reference herein in their entirety.

### TECHNICAL FIELD

The invention relates to a secure mailing envelope suitable for mailing wireless communication devices, such as contactless integrated circuit (IC) cards, so that the devices are electromagnetically shielded in transit. The invention also relates to a method for manufacturing the envelope.

### BACKGROUND

Contactless payment cards are used as a means of payment for various goods and services. An account balance is stored on an integrated circuit (IC) attached to the card and transactions can be carried out by radio frequency (RF) wireless communication between the card and a reader. For example, such a card could be used to pay for an item in a shop simply by bringing the card into proximity with a merchant terminal equipped with a suitable RF reader. Using a contactless payment card is quicker than using a conventional credit card, which must be passed through a magnetic strip reader or inserted into a merchant terminal. Thus, contactless payment cards can replace the use of cash in many common situations where using a conventional credit card would be too slow and inconvenient for the user.

Contactless payment cards store and transmit data in encrypted form and may also require a customer to enter a PIN number in order to make a payment. Despite these security measures, the possibility of information held on the card being illegally accessed by third parties and being used to make fraudulent transactions remains. One opportunity for criminals to access information held on a contactless payment card is during posting of the card to a customer. Payment cards are usually posted to customers in standard paper envelopes. Unfortunately, a contactless payment card posted in this way is vulnerable to illegal access because wireless communication with the card through the envelope is possible. A criminal could use a portable RF reader to access information held on the card inside the envelope without opening the envelope, thereby avoiding leaving any evidence of tampering.

It has recently been proposed to use an envelope having RF shielding to post contactless payment cards. For example, WO 2006/107778 discloses an envelope containing a contactless payment card, the envelope having a piece of RF-shielding material disposed on an interior surface proximate to the enclosed card.

However, the present inventors have found that currently known RF-shielding envelopes do not provide sufficient protection to prevent a contactless payment card within the envelope from being read. This problem extends to posting any type of wireless communication device that it would be undesirable for third parties to access. For example, this problem could also arise in posting driving licences or ID cards having a wireless communication capability. Furthermore, it has proved difficult to provide an effective RF-shielding envelope that can be mass-produced.

### SUMMARY

The present invention has been developed to solve the above problems. One embodiment provides a mailing envelope comprising: an outer paper layer forming a pocket; and an inner foil layer lining an inner surface of the outer paper layer within the pocket; wherein the foil layer includes an aluminium foil having a thickness in a range of 6 to 10 μm.

The present inventors have discovered that lining a paper envelope with an aluminium foil having a thickness between 6 and 10 μm provides adequate protection for a contactless card within the envelope. The foil acts as a Faraday cage, interfering with RF communication between the inside and the outside of the envelope to the extent that the contactless card cannot be accessed from outside.

Using an aluminium foil having a thickness of 10 μm or less provides the advantage that the envelope can be mass-produced at a relatively low cost using existing envelope manufacturing machines. The inventors have found that using a thicker foil greatly increases the cost of manufacturing the envelope because a foil thicker than 10 μm is difficult to machine.

In one embodiment, a window is formed through the outer paper layer and the inner foil layer. Providing a transparent address window is advantageous because it allows cards to be automatically packaged for posting with the address displayed on the envelope, without requiring an additional step of sticking an address label to the outside of the envelope. Any additional packaging steps add to the cost of supplying the cards to customers.

Embodiments of the envelope have been found to prevent RF communication with a contactless card disposed within it even if an address window is formed in the envelope. This is a surprising result since it had previously been thought that providing an address window would prevent an envelope from shielding a card within it. The inventors have found that a contactless card can be shielded by embodiments of the envelope even if the card is positioned so that the window opens onto part or all of the card.

Suitably, the inner surface of the outer paper layer includes two opposing surfaces forming the pocket and the foil layer covers both opposing surfaces. In one embodiment, the inner foil layer forms a continuous conductive loop extending across both opposing surfaces.

Suitably, the aluminium foil is coated with a lacquer. Conveniently, the lacquer is a water-based acrylic lacquer. In one embodiment, the lacquer comprises nitro-cellulose. In one embodiment, the foil layer is adhered to the paper layer by an adhesive.

Conveniently, the outer paper layer has an upper flap extending from a front edge of the outer paper layer defining an opening of the pocket and the foil layer covers a rear surface of the upper flap. Suitably, the envelope is adapted to be sealed by adhering the inner foil layer at the rear surface of the upper flap to a rear outer surface of the outer paper layer. In one embodiment, a layer of adhesive is formed on the foil layer at the rear surface of the upper flap.

In embodiments, the aluminium foil has a thickness in a range of 7 to 9 μm. In one embodiment, for example, the aluminium foil has a thickness of 8 μm.

Further embodiments provide a mailing envelope comprising: an outer paper layer forming a pocket; and an inner foil layer lining an inner surface of the outer paper layer within the pocket; wherein the inner foil layer includes an aluminium foil coated with a lacquer.

An envelope to be used in posting contactless cards must of course be sealable to prevent tampering with the cards in transit. In developing embodiments of the envelope, the inventors found that it is impossible to seal an envelope using a conventional adhesive when the envelope has an aluminium foil flap because the adhesive will not adhere to the foil. This problem would prevent the shielding envelope being sealed by conventional mailing machines. However, the inventors discovered that the problem can be overcome by applying a lacquer to the aluminium foil before applying an adhesive. The lacquer acts as a primer allowing the adhesive to adhere to the flap.

Conveniently, the lacquer is a water-based acrylic lacquer. In one embodiment, the lacquer comprises nitro-cellulose. In one embodiment, the inner foil layer is adhered to the outer paper layer by an adhesive. The lacquer coating also allows adhesive to be used to adhere the inner foil layer to the outer paper layer to form the envelope.

In another embodiment, there is provided a package comprising: a mailing envelope as described above; and a wireless communication device disposed within the envelope.

In another embodiment, there is provided a method for manufacturing a mailing envelope comprising: adhering a paper layer to an aluminium foil layer to form a laminated sheet; forming a window through the laminated sheet; and folding the laminated sheet to form a pocket, the foil layer lining the inside of the pocket.

### BRIEF DESCRIPTION OF THE DRAWINGS

Embodiments of the present invention will now be described by way of further example only and with reference to the accompanying drawings, in which:

FIG. 1 shows an outer paper layer for an envelope according to an embodiment (front view).

FIG. 2 shows an inner foil layer for an envelope according to an embodiment (rear view).

### DETAILED DESCRIPTION

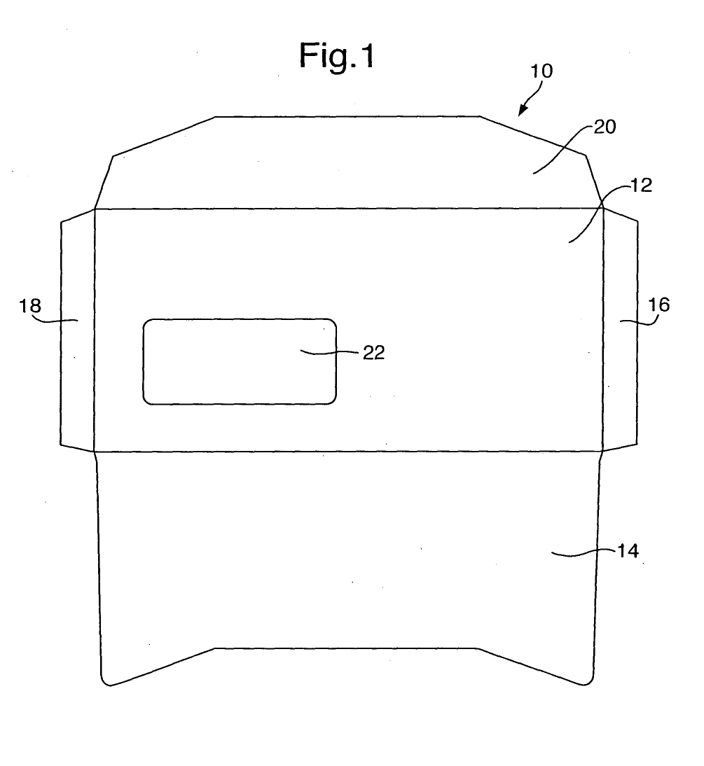

According to one embodiment, the envelope comprises an outer paper layer 10 as shown in FIG. 1. The paper layer 10 is shown unfolded. In the completed envelope, lower flap 14 is folded inwards so as to lie against the back surface of main body 12. Side flaps 16 and 18 are also folded inward and attached to the exposed surface of lower flap 14, thereby forming the pocket of the envelope.

Transparent address window 22 is formed in the main body of the envelope and allows an address printed on a sheet inside the envelope to be seen from the outside. The window is covered by a layer of transparent plastics material.

The paper used for the outer paper layer 10 in this embodiment is 90 gsm cartridge paper, but any paper suitable for forming a postal envelope may be used. It is desirable that the paper used is of a type used in standard envelopes so that the envelope is not recognisable as containing a contactless payment card from the outside.

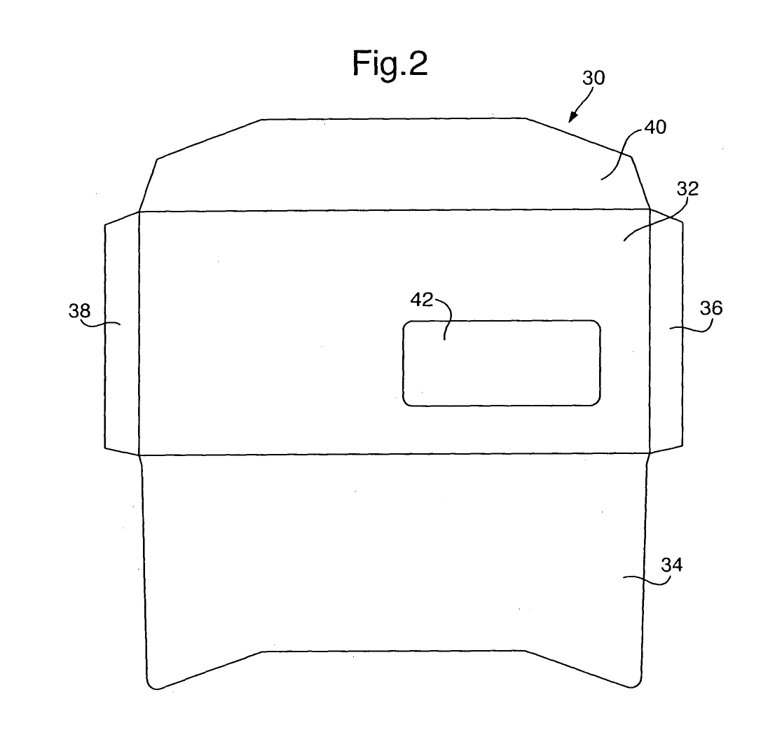

The inner foil layer 30 used in this embodiment is shown in FIG. 2. The shape of the inner foil layer 30 corresponds to that of the outer paper layer 10. A window 42 is formed in the foil layer 30 at a location matching that of the window 22 in the paper layer 10 when the two layers 10, 30 are placed one on top of the other with the flaps overlapping completely.

In the completed envelope, the foil layer 30 lines the inside of the paper layer 10. The flaps and body 32-40 of the foil layer 30 overlap the corresponding flaps and body 12-20 of the paper layer 10. Specifically, the upper flap 40 of the foil layer 30 overlaps the upper flap 20 of the paper layer 10, the lower flap 34 of the foil layer 30 overlaps the lower flap 14 of the paper layer 10, the side flaps 36 and 38 of the foil layer 30 overlap the side flaps 16 and 18 of the paper layer 10, and the main body 32 of the foil layer 30 overlaps the main body 12 of the paper layer 10.

The foil layer 30 is formed from 8 μm thick aluminium foil in this embodiment. This thickness has been found to provide a particularly good balance between effective RF-shielding of the contents of the envelope and machinability of the envelope during manufacture. Thicker foils are difficult to work with in manufacturing the envelope and thinner foils disrupt RF communication between the inside and the outside of the envelope less effectively.

The foil layer 30 is coated with a primer layer of water-based acrylic lacquer at 0.8 gsm. The foil layer 30 and the paper layer 10 are bonded together using an adhesive, for example sodium silicate at 1.5 gsm. Hence, when folded as described above, the completed envelope comprises a foil-lined pocket open at the boundary between main body 12 and upper flap 20. A window 22, 42 is formed through both the paper layer 10 and the foil layer 30 of the envelope.

The folded foil layer 30 forms a continuous conductive loop, extending across the front surface of the envelope and returning across the rear surface of the envelope in the direction parallel to the opening of the envelope. The front portion and the rear portion of the foil are in contact at the boundary between the side flaps 36, 38 and the main body 32. This continuous conductive loop enhances the shielding effect provided by the envelope.

An adhesive is applied to the exposed surface of the foil upper flap 40. The primer layer allows the adhesive to stick to the foil. Hence, the envelope can be sealed by adhering the exposed surface of the foil upper flap 40 to the outer surface of the paper lower flap 14. This allows the envelope to be sealed by conventional automatic mailing machines.

In use of the envelope, a contactless card is attached to a paper or cardboard insert and placed within the envelope. A destination address is printed either on the insert or on an enclosed letter and arranged such that the address is visible through the window 22, 42. The envelope is then sealed and posted.

In one embodiment, the envelope is manufactured as follows. Firstly, a sheet of aluminium foil is coated with a water-based acrylic lacquer. Next, a paper sheet is adhered to the sheet of aluminium foil to form a laminated sheet. The laminated sheet is cut into the unfolded envelope shape shown in FIGS. 1 and 2, having a window formed in the sheet. Thus, the outer paper layer 10 and the inner foil layer 30 are formed and are adhered to each other. A sheet of transparent plastics material is then adhered to the outer paper layer 10 so as to cover the window 22.

The lower flap of the laminated sheet is folded inward so as to extend over the back surface of the foil main body 32. The laminated side flaps are then folded inward and the inner surfaces of the foil layer at the side flaps 36, 38 are adhered to the outer surface of the paper layer at the lower flap 14 so as to fix the laminated sheet in the folded configuration. Finally, a strip of adhesive is applied to the inner surface of the foil layer at the upper flap 40.

The foregoing description has been given by way of example only and it will be appreciated by a person skilled in the art that modifications can be made without departing from the scope of the present invention as defined by the claims.

1. A mailing envelope comprising:
an outer paper layer forming a pocket; and
an inner foil layer lining an inner surface of the outer paper layer within the pocket;
wherein the foil layer includes an aluminium foil having a thickness in a range of 7 to 9 μm.

2. A mailing envelope according to claim 1, wherein a window is formed through the outer paper layer and the inner foil layer.

3. A mailing envelope according to claim 1, wherein the inner surface of the outer paper layer includes two opposing surfaces forming the pocket and the foil layer covers both opposing surfaces.

4. A mailing envelope according to claim 3, wherein the inner foil layer forms a continuous conductive loop extending across both opposing surfaces.

5. A mailing envelope according to claim 1, wherein the aluminium foil is coated with a lacquer.

6. A mailing envelope according to claim 5, wherein the lacquer is a water-based acrylic lacquer.

7. A mailing envelope according to claim 5, wherein the lacquer comprises nitro-cellulose.

8. A mailing envelope according to claim 5, wherein the foil layer is adhered to the paper layer by an adhesive.

9. A mailing envelope according to claim 1, wherein the outer paper layer has an upper flap extending from a front edge of the outer paper layer defining an opening of the pocket and the foil layer covers a rear surface of the upper flap.

10. A mailing envelope according to claim 9, wherein the envelope is adapted to be sealed by adhering the inner foil layer at the rear surface of the upper flap to a rear outer surface of the outer paper layer.

11. A mailing envelope according to claim 10, wherein a layer of adhesive is formed on the foil layer at the rear surface of the upper flap.

12. A mailing envelope according to claim 1, wherein the aluminium foil has a thickness of 8 μm.

13. A mailing envelope comprising:
an outer paper layer forming a pocket; and
an inner foil layer lining an inner surface of the outer paper layer within the pocket;
wherein the inner foil layer includes an aluminium foil coated with a lacquer.

14. A mailing envelope according to claim 13, wherein the lacquer is a water-based acrylic lacquer.

15. A mailing envelope according to claim 13, wherein the lacquer comprises nitro-cellulose.

16. A mailing envelope according to claim 13, wherein the inner foil layer is adhered to the outer paper layer by an adhesive.

17. A mailing envelope according to claim 13, wherein a window is formed through the outer paper layer and the inner foil layer.

18. A mailing envelope according to claim 13, wherein the inner surface of the outer paper layer includes two opposing surfaces forming the pocket and the foil layer covers both opposing surfaces.

19. A mailing envelope according to claim 18, wherein the inner foil layer forms a continuous conductive loop extending across both opposing surfaces.

20. A mailing envelope according to claim 13, wherein the outer paper layer has an upper flap extending from a front edge of the outer paper layer defining an opening of the pocket and the foil layer covers a rear surface of the upper flap.

21. A mailing envelope according to claim 20, wherein the envelope is adapted to be sealed by adhering the rear surface of the upper flap to a rear outer surface of the outer paper layer.

22. A mailing envelope according to claim 21, wherein a layer of adhesive is formed on the foil layer covering the rear surface of the upper flap.

23. A package comprising:
a mailing envelope comprising an outer paper layer forming a pocket and an inner foil layer lining an inner surface of the outer paper layer within the pocket, wherein the foil layer includes an aluminium foil having a thickness in a range of about 7 μm to about 9 μm; and
a wireless communication device disposed within the envelope.

24. A method for manufacturing a mailing envelope comprising:
coating an aluminium foil layer with a lacquer;
adhering a paper layer to the foil layer to form a laminated sheet;
forming a window through the laminated sheet; and
folding the laminated sheet to form a pocket, the foil layer lining the inside of the pocket.
